(19) United States
(12) Patent Application Publication
(10) Pub. No.: US 2010/0146114 A1
(43) Pub. Date: Jun. 10, 2010

(54) Methods, Systems, And Computer Program Products For Accessing A Resource Based On Metadata Associated With A Location On A Map

(76) Inventor: Robert P. Morris, Raleigh, NC (US)

Correspondence Address: SCENERA RESEARCH, LLC, 111 CORNING RD., SUITE 220, CARY, NC, 27518, US

(21) Appl. No.: 12/328,055

(22) Filed: Dec. 4, 2008

(51) Int. Cl. G06F 15/173

(52) U.S. Cl. 709/225

(57) ABSTRACT

Methods and systems are described for accessing a resource based on metadata associated with a location on a map. In one aspect, a map is provided representing a geospatial region. A resource accessible via a network address identifying a network interface of a resource provider node has a geospatial location in the geospatial region and the location is associated with the network address. Resource information identifying the resource to the resource provider and location information identifying a map location representing the geospatial location in the map representing the geospatial region is received. The resource information is associated as resource metadata with the map location. Accessing the resource via the map with the network address of the resource provider determined based on the geospatial location represented by the map location and the resource metadata identifying the resource to the resource provider.

### RELATED APPLICATIONS

This application is related to the following commonly owned U.S. patent applications, the entire disclosure of each being incorporated by reference herein:

application Ser. No. 11/962,285 (Attorney Docket No I509/US) filed on Dec. 21, 2007, entitled “Methods And Systems For Sending Information To A Zone Included In An Internet Network”;

application Ser. No. 12/170,281 (Attorney Docket No I522/US) filed on Jul. 10, 2008, entitled “Methods And Systems For Resolving A Geospatial Query Region To A Network Identifier”;

application Ser. No. 12/170,829 (Attorney Docket No I523/US) filed on Jul. 10, 2008, entitled “Methods And Systems For Resolving Location Information To A Network Identifier”;

application Ser. No. 12/170,833 (Attorney Docket No I524/US) filed on Jul. 10, 2008, entitled “Methods And Systems For Resolving A Query Region To A Network Identifier”;

application Ser. No. ______ (Attorney Docket No I496/US) filed on ______, entitled “Methods, Systems, And Computer Program Products For Browsing Using A Geospatial Map Metaphor”;

application Ser. No. ______ (Attorney Docket No I508/US) filed on ______, entitled “Methods, Systems, And Computer Program Products For Associating Resources Of A First Geospace With A Second Geospace”;

application Ser. No. ______ (Attorney Docket No I515/US) filed on ______, entitled “Methods, Systems, And Computer Program Products For Harmonizing A Geospatial Domain Space With A Non-Geospatial Domain Space”;

application Ser. No. ______ (Attorney Docket No I527/US) filed on ______, entitled “Methods, Systems, And Computer Program Products For Determining A Network Identifier Of A Node Providing A Type Of Service For A Geospatial Region”; and

application Ser. No. ______ (Attorney Docket No I534/US) filed on ______, entitled “Methods, Systems, And Computer Program Products For Accessing A Resource Having A Network Address Associated With A Location On A Map.”

### BACKGROUND

Current web browsers do not provide a user with a sense of location for easing navigation and for knowing a location of a resource browsed. Browsers take users from one page to another with no transition that relates the two pages. Some pages provide information that relates them to other pages using, for example, links labeled “back” and “next. This provides a sense of location only within a select group of web pages.

### SUMMARY

Having sense of “where you are” on the web would raise the comfort level of many users and ease navigation for others. Methods and systems are described for accessing a resource based on metadata associated with a location on a map. In one aspect, a map is provided representing a geospatial region. A resource accessible via a network address identifying a network interface of a resource provider node has a geospatial location in the geospatial region and the location is associated with the network address. Resource information identifying the resource to the resource provider and location information identifying a map location representing the geospatial location in the map representing the geospatial region is determined. The resource information is associated as resource metadata with the map location. Providing for accessing the resource via the map with the network address of the network interface of the resource provider determined based on the geospatial location represented by the map location and the resource metadata identifying the resource to the resource provider.

In another aspect, a system for accessing a resource based on metadata associated with a location on a map includes means for providing a map representing a geospatial region wherein a resource accessible via a network address identifying a network interface of a resource provider node has a geospatial location in the geospatial region. The geospatial location is associated with the network address. The system also includes means for receiving resource information identifying the resource to the resource provider node and location information identifying a map location representing the geospatial location in the map representing the geospatial region. The system also includes means for associating the resource information as resource metadata with the map location and means for providing for accessing the resource via the map with the network address identifying the network interface of the resource provider determined based on the geospatial location represented by the map location and the resource metadata identifying the resource to the resource provider.

In another aspect, a system for accessing a resource based on metadata associated with a location on a map includes a map handler component configured to provide a map representing a geospatial region, wherein a resource accessible via a network address identifying a network interface of a resource provider node has a geospatial location in the geospatial region. The geospatial location is associated with the network address. The system also includes a content handler component configured to receive resource information identifying the resource to the resource provider node and location information identifying a map location representing the geospatial location in the map representing the geospatial region. The system also includes a navigation space handler component configured to associate the resource information as resource metadata with the map location. The content handler component is further configured to provide for accessing the resource via the map with the network address identifying the network interface of the resource provider determined based on the geospatial location represented by the map location and the resource metadata identifying the resource to the resource provider.

In another aspect, a computer readable medium is defined embodying a computer program, executable by a machine, for accessing a resource based on metadata associated with a location on a map. The computer program includes executable instructions for providing a map representing a geospatial region, wherein a resource accessible via a network address of a resource provider node has a geospatial location in the geospatial region, the geospatial location associated with the network address. The computer program also includes executable instructions for receiving resource information identifying the resource to the resource provider node and location information identifying a map location representing the geospatial location in the map representing the geospatial region. The computer program also includes executable instructions for associating the resource information as resource metadata with the map location and providing for accessing the resource via the map with the network address of the resource provider determined based on the geospatial location represented by the map location and the resource metadata identifying the resource to the resource provider.

### BRIEF DESCRIPTION OF THE DRAWINGS

Advantages of the claimed subject matter will become apparent to those skilled in the art upon reading this description in conjunction with the accompanying drawings, in which like reference numerals have been used to designate like or analogous elements, and in which:

FIG. 1 is a flow diagram illustrating a method for accessing a resource based on metadata associated with a location on a map according to an aspect of the subject matter described herein;

FIG. 2 is block a diagram illustrating a system for accessing a resource based on metadata associated with a location on a map according to another aspect of the subject matter described herein;

FIG. 3 is a block diagram illustrating an exemplary execution environment in which the system of FIG. 2 is operable;

FIG. 4 is a block diagram illustrating an example of receiving resource information in a result sent in response to a request;

FIGS. 5A-5D are exemplary graphical user interfaces for presenting a representation of a map;

FIG. 6 is a block diagram illustrating an alternate system for accessing a resource based on metadata associated with a location on a map according to another aspect of the subject matter described herein; and

FIG. 7 is a block diagram illustrating an exemplary execution environment in which the system of FIG. 6 is operable.

### DETAILED DESCRIPTION

Prior to describing the subject matter in further detail, certain terms used in the description shall be defined to aid the reader.

A geospatial domain space can be divided into one or more geospatial regions where each region is associated with a domain in the geospatial domain space. Each region is a referred to as a domain region. A geospatial region of a geospatial domain space or location in the geospatial region can be associated with a geospatial identifier that uniquely identifies the region/location in the context of the geospatial domain space. For example, the surface of the Earth, in whole and in part, has been and continues to be identified based on various types of 2-dimensional and 3-dimensional identifier spaces. Some identifier spaces are associated with a grid system where each grid is identified by a tuple of coordinates, for example, a coordinate pair where one identifies a region in a horizontal orientation, and one identifies a region in a vertical orientation. The coordinate pair together identifies a region defined by intersection of the horizontal region and the vertical region. Several forms of GPS coordinate sets are currently in use including a Degrees/Minutes/Seconds identifier space, a Degree Decimal Minutes identifier space, and a Universal Transverse Mercator (UTM) identifier space. A geospatial identifier associated with a geospatial domain space does not have to be coordinate-based. Any geospatial identifier that can identify regions/locations in the space is within the scope of the subject matter. For example, USA, N.C., Cary, 111 Corning Rd, Suite 220 is a geospatial identifier identifying a business work site in the space that is occupied by the Earth for identifying a location on the Earth.

A geospatial Identifier can be any identifier that includes a portion that is usable for identifying a region/location of a geospatial domain space. Geospatial identifiers can be defined for specifying or otherwise identifying regions and locations having a variety of shapes including rectangles, circles, oval, or any shape including a closed region. A geospatial identifier can identify a region with disjoint sub-regions by including a geospatial attribute that identifies the sub-regions. For example, the identifier, “40+”, from an identifier space including average annual rainfall totals over a specified period identifies a geospatial region including all sub-regions that have an average annual rainfall over 40 inches.

A network address is a network layer address identifier for a network interface (unicast) of a node or a set of network interfaces (multicast or broadcast) of a corresponding set of nodes. The terms address and network address are used interchangeably unless otherwise noted. A network address can be specified with a format including a node portion (a portion that identifies a network interface of a node, which is a device that is operatively coupled to a network) and a domain portion (a portion that specifies a domain an identifier space within a domain space). In the Internet protocol address domain space, a domain portion identifies a portion of an internet also known as a subnet. In the domain name system (DNS) name space a domain portion identifies a naming domain in which names of nodes and subdomains are unique within the particular naming domain. A geospatial domain space can include geospatial network addresses or geospatial symbolic identifiers such as names. At least a domain portion of a geospatial identifier from a geospatial domain space identifies a region.

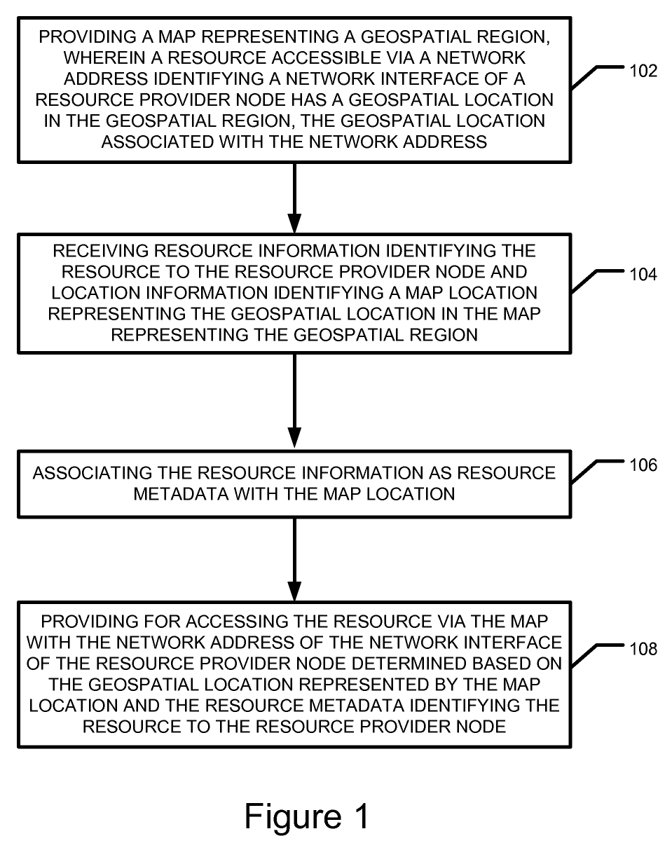

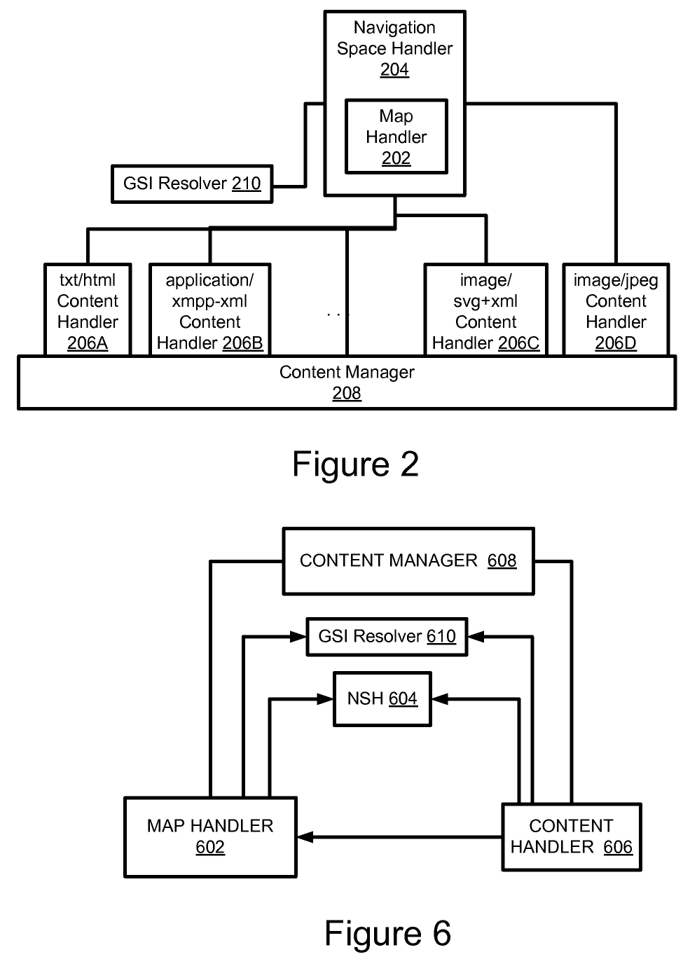

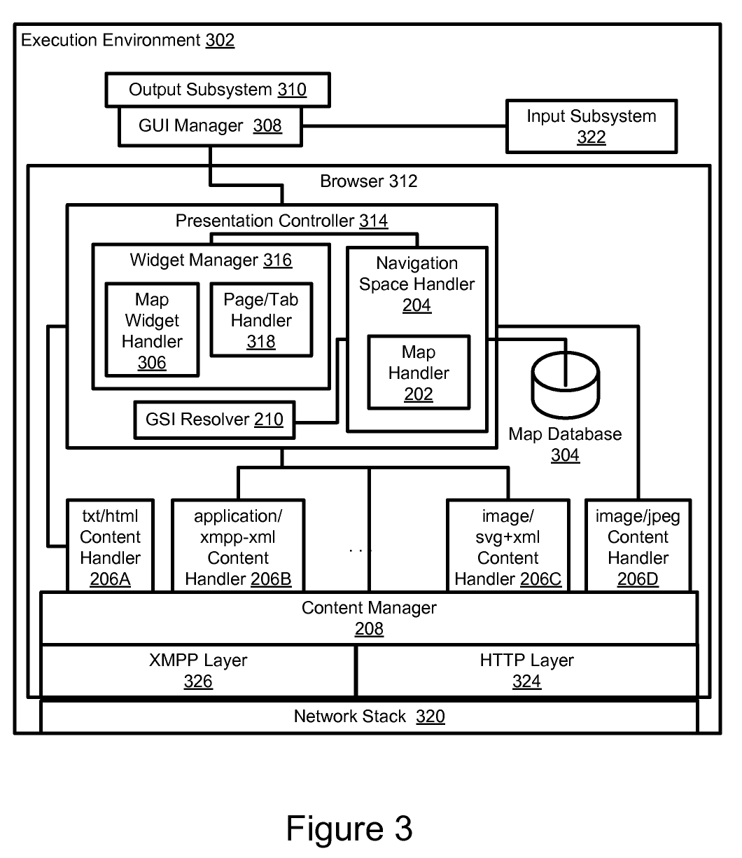

FIG. 1 is a flow diagram illustrating a method for accessing a resource based on metadata associated with a location on a map according to an exemplary aspect of the subject matter described herein. FIG. 2 is a block diagram illustrating a an arrangement of components configured to access a resource based on metadata associated with a location on a map according to another exemplary aspect of the subject matter described herein. FIG. 3 is a block diagram illustrating an arrangement of components providing an execution environment configured to host the arrangement of components in FIG. 2. The method illustrated in FIG. 1 can be carried out by, for example, some or all of the components illustrated in FIG. 2 operating in a compatible execution environment, such as the environment provided by some or all of the components illustrated in FIG. 3.

With reference to FIG. 1, in block 102 a map representing a geospatial region is provided, wherein a resource accessible via a network address identifying a network interface of a resource provider node has a geospatial location in the geospatial region. The resource can be a resource provider or accessible from a resource provider. The geospatial location is associated with the network address. Accordingly, a system for accessing a resource based on metadata associated with a location on a map includes means for providing a map representing a geospatial region, wherein a resource accessible via a network address identifying a network interface of a resource provider node has a geospatial location in the geospatial region, the geospatial location associated with the network address. For example, as illustrated in FIG. 2, a map handler component 202 is configured to provide a map representing a geospatial region, wherein a resource accessible via a network address identifying a network interface of a resource provider node has a geospatial location in the geospatial region, the geospatial location associated with the network address.

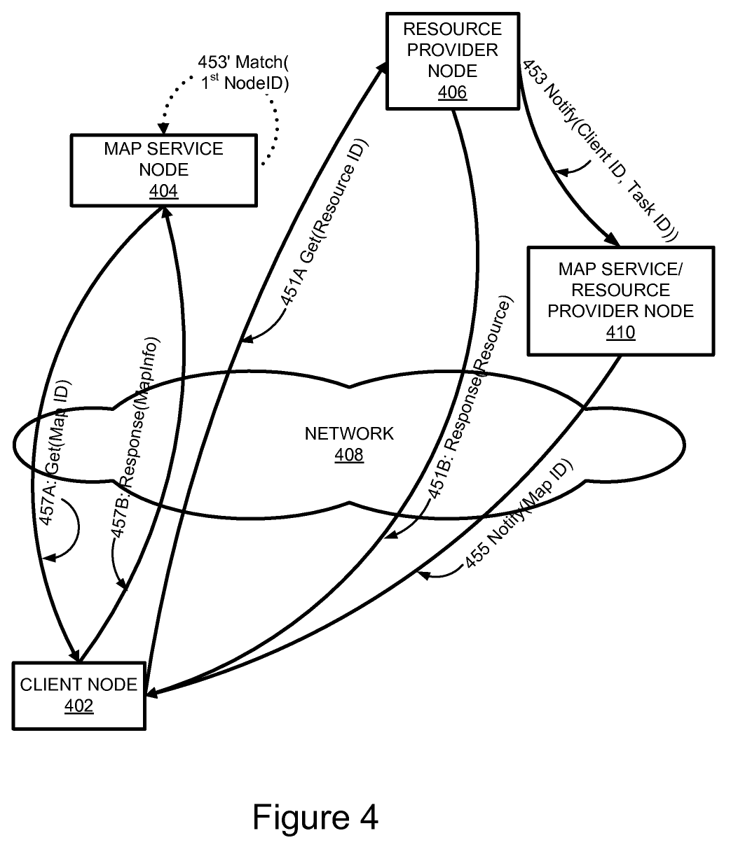

Turning now to FIG. 2, the arrangement of components shown can be adapted to operate in a variety of execution environments. FIG. 3 illustrates the components in FIG. 2 adapted to operate in an execution environment 302 provided by components illustrated in FIG. 3. An execution environment can include a memory for storing components and an instruction processing component, such as processor and/or a digital signal processor (DSP), for processing instructions and any data associated with the operation of the components illustrated in FIG. 2. The components illustrated in FIG. 2, and functionally analogous components, each can require additional hardware and/or software subsystems according to their particular operational requirements. Any execution environment capable of hosting the arrangement of components in FIG. 2 or their analogs is suitable. A suitable execution environment can be hosted by a device such as a client node 402 illustrated in FIG. 4. Alternatively a suitable execution environment can be a distributed execution environment provided by multiple nodes. Exemplary nodes providing suitable execution environments include desktop computers, servers, notebook computers, mobile phones, PDAs, audio and/or video capture devices, and the like.

The map handler component 202, as illustrated in FIG. 2, is configured to provide a map. The map handler component 202 can retreive/receive map information to provide a map from one or more sources including a local data store (e.g., map database 304 illustrated in FIG. 3), a remote map service (hosted by a map service node 404), and/or a resource provider (hosted by a resource provider node 406). A map can be generated or otherwise provided by the map handler component 202 based on the map information.

FIG. 3 illustrates a map handler component 202 adapted to operate in the execution environment 302. The map can be provided by the map handler component 202 to a map widget handler component 306 via a navigation space handler (NSH) 204. The NSH component 204 can be configured to translate addresses from one address space to another. For example, the NSH component 204 can be configured to translate an address from a map address space of a particular map to an address of a presentation space provided by an instance of the map widget handler component 306. The map widget handler component 306 can be configured to store a representation of the map in a presentation space for presenting on a display (not shown) via a GUI manager component 308 coupled to an output subsystem 310 included in the execution environment 302.

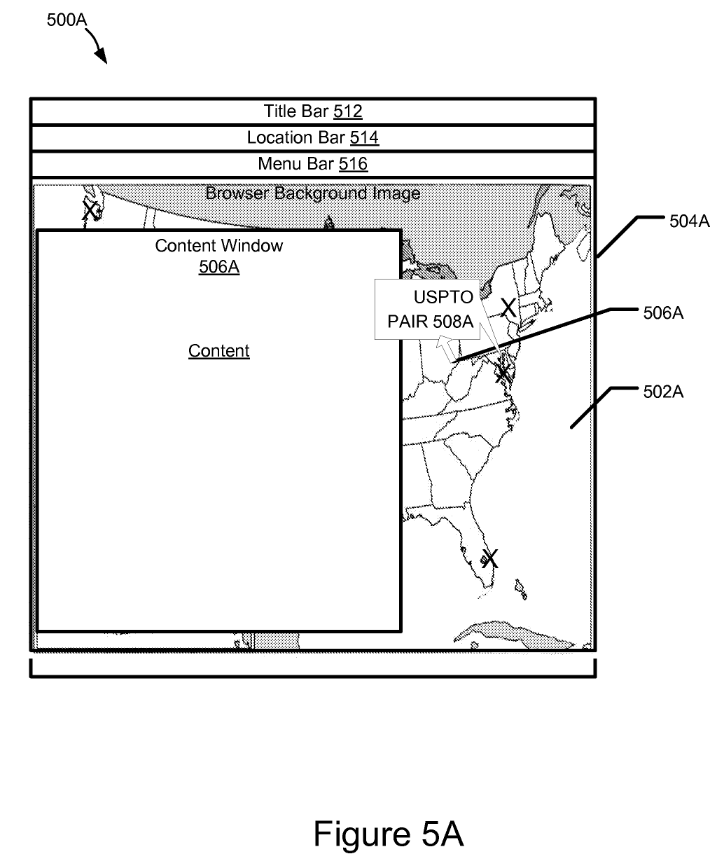

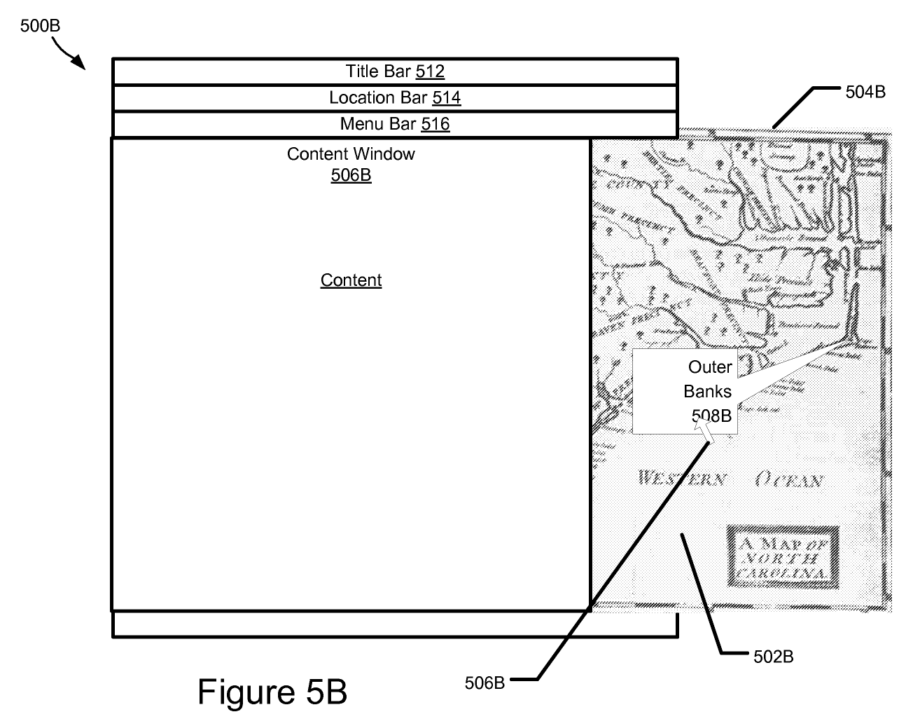

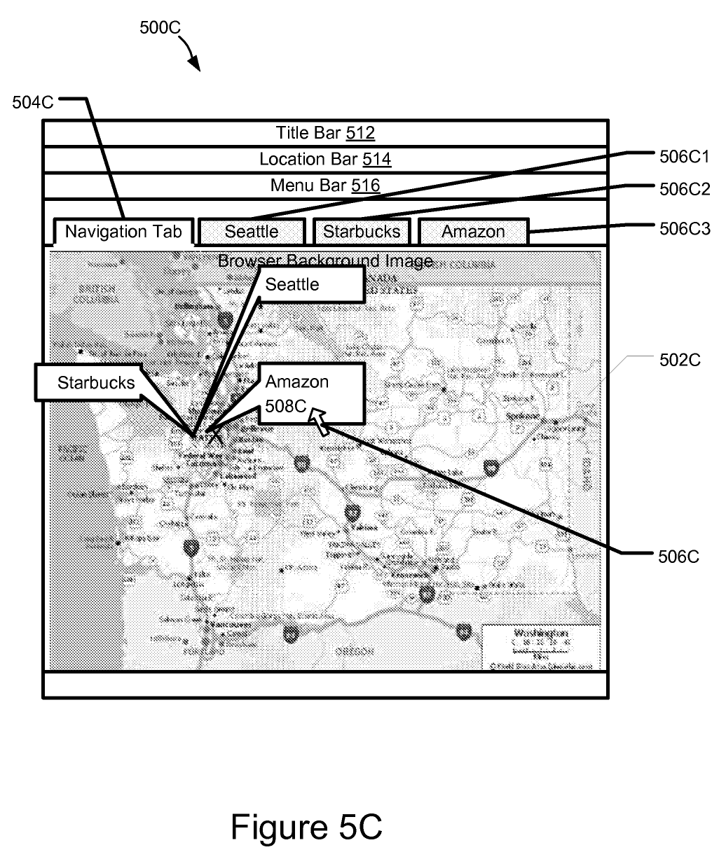

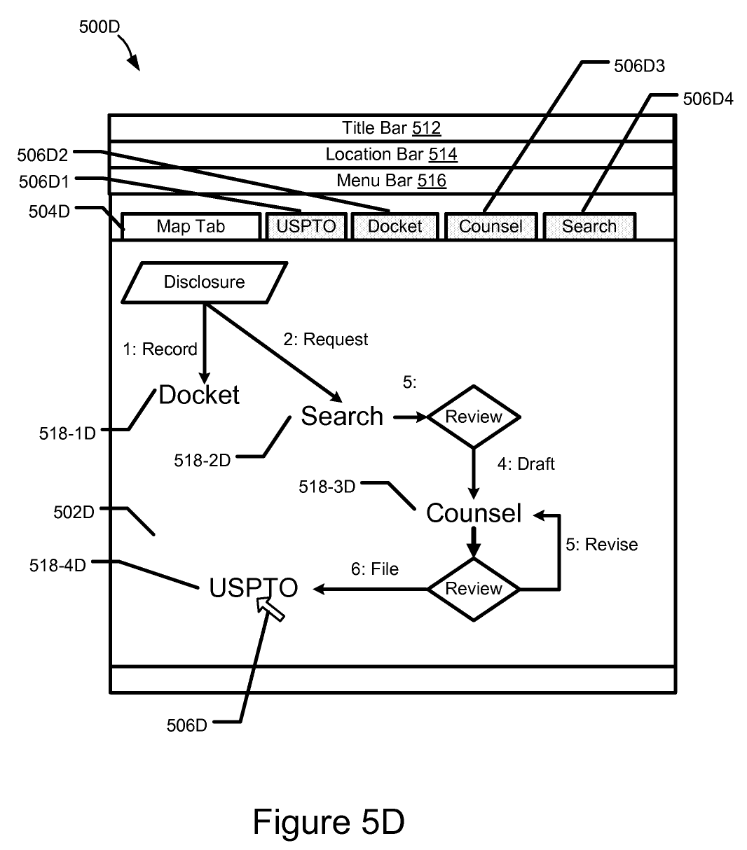

Exemplary graphical user interfaces (GUIs) 500A-500D are illustrated in FIGS. 5A-D, respectively, and are referred to generically as GUI 500. Similarly, maps 502A, 502B, 502C, and 502D are referred to generically as map 502, map widget 504A, 504B, 504C, 504D are referred to as map widget 504, etc. A map 502 may depict one or more map marks, “X's” indicating locations associated with resources and/or resource providers. An “X” may be associated with a flyover text widget 508 identifying the content. For example, flyover text widget 508A identifies the resource/resource provider as the United States Patent and Trademark Office (USPTO), flyover text widget 508B identifies the Outer Banks of North Carolina, etc. An arrow icon 506 is presented as a visual indicator over a flyover text associated with the map mark. A GUI 500 illustrates a number of widgets typically presented by a web browser, such as a browser 312, or other browsing enabled application. The GUI 500 can be presented via presentation controller component 314 in the browser 312. The presentation controller component 314 can be configured to coordinate the presentation of one or more widgets generated and managed by corresponding widget handlers that can be created, deleted, and otherwise managed by a widget manager component 316 interoperating with the presentation controller component 314 and other components in the browser 312 and the execution environment 302.

In a GUI 500, a map 502 is presented in a presentation space of map widget 504 that is generated and managed by an instance of the map widget handler component 306. The map widget 504 can be a type of a page/tab widget generated and managed by an instance of the page/tab widget handler component 318. Thus, the map widget handler component 306 can be a type or subclass of the page/tab widget handler component 318. Alternatively, a map widget can be presented in a presentation space of a page/tab widget.

One or more received/retrieved resources can be presented in the presentation space of a content window widget 506 generated by a corresponding widget handler (not shown) of the browser 312. Each of the GUIs 500 also illustrates a title bar widget 512, a location bar widget 514, and a menu bar widget 516 that are well-known to current browser users. Each can be generated and managed by a corresponding instance of a widget handler component managed by the widget manager component 316.

Presentation on a display can be coordinated by the presentation controller component 314 interoperating with a GUI manager component 308 included in the execution environment 302. The GUI manager component 308 can be configured to direct the output subsystem 310 to present the widgets on a display as directed by corresponding widget handler components.

Map information for providing a map 502 can be retrieved in association with an accessed resource provider hosted by a resource provider node 406 illustrated in FIG. 4 and/or a particular resource provided by the resource provider. A map can be selected dynamically or manually via user selection and/or configuration. Map information for a map can be made accessible depending on an attribute of a service provider, a resource, a user, a task, a location, a network to which device is connected, other communication, and the like.

Note that resource information and/or location information may be received in a result sent in response to a prior request. In FIG. 4, the client node 402 is illustrated sending a request illustrated as a Get message 451A identifying a resource to the resource provider node 406. The resource provider node 406 is illustrated responding with a corresponding response message 451B including the resource or a resource reference sent via the network 408 to the client node 402. The resource provider 406 can be configured to send a notify message 453 identifying the client node 402 and optionally a task, as illustrated, associated with the requested resource to a map service hosted by a node 410 in response to receiving the Get message 451A and/or sending the response message 451B. In response to receiving the notify message 453, the map service operating in the node 410 can be configured to locate map information for a map based on the information in the notify message 453, such as a task ID, and can send, as illustrated, a notify message 455 to the client node 402 identifying the map. Alternatively, the notify message 455 can include map information for the identified map for presenting the map 502 such as SVG (Scalable Vector Graphic) content and/or an image of a map 502.

In an example, when the notify message 455 includes a reference to map information, the client node 402 can request map information for the identified map from another node hosting a map service, such as a map service node 404 illustrated in FIG. 4. The request is illustrated by the get message 457A identifying the map associated with the task involving the requested resource. The requested map information can be returned to the map handler component 202 in the client node 402 for providing the map 502.

Map 502D in FIG. 5D illustrates an exemplary map associated with a task involving a number of steps including accessing resources provided by multiple service providers including the US Patent and Trademark Office 518-4D, a patent docketing service 518-1D, a search service 518-2D, and a web application providing legal counsel from a law firm 518-3D. The map 502D shows the steps in the task and their order and the associated service providers. Initially the map can be blank or can present a template for the task without representations of one or more of the resources such as the service providers.

Map information for a map 502 can be retrieved from a map database 304 operating locally in the execution environment 302 or operating in another execution environment hosted by a remote node, such as the map service node 404, as previously described with respect to FIG. 4. In an alternative aspect, map information can be included in a message including resource information and/or location information such as the response message 451B.

Now that providing a map representing a geospatial region wherein a resource has a location in the geospatial region and is identifiable to a resource provider having a network interface accessible via a network address has been described from a client perspective, a perspective of a map service and/or resource provider shall now be described.

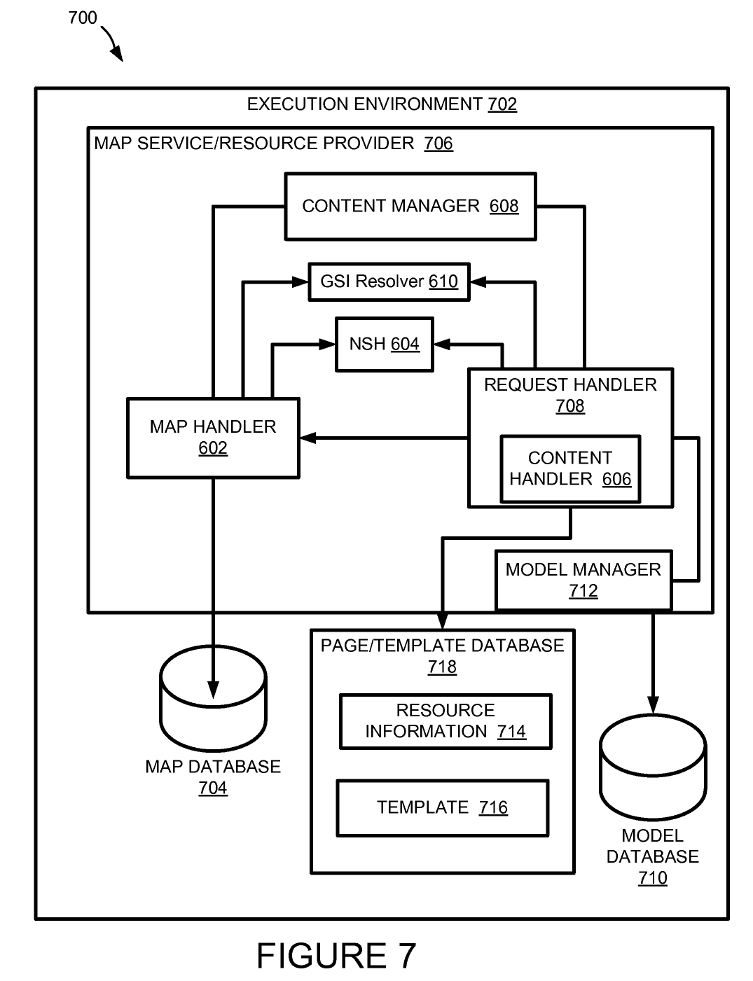

An arrangement of components including a map handler component 602 is illustrated in FIG. 6. The components in FIG. 6 can be adapted to operate in a variety of execution environments. FIG. 7 illustrates the components in FIG. 6 adapted to operate in an execution environment 702 provided by an arrangement of components illustrated in in FIG. 7. Any execution environment capable of hosting the arrangement of components in FIG. 6 or their analogs is suitable. A suitable execution environment can be hosted by a device such as a map service node 404, a resource provider node 406, and/or a node 410 providing an execution environment suitable for both a map service and a service provider as illustrated in FIG. 4. Alternatively a suitable execution environment can be a distributed execution environment provided by multiple nodes. Exemplary nodes providing suitable execution environments include servers, desktop computers, notebook computers, mobile phones, PDAs, audio and/or video capture devices, and the like. In the description that follows, the component 706 may be used as a map service or a resource provider or an integrated map service/resource provider. As these are different embodiments of the component, subscripts shall be used to designate the map service, resource provider, and map service/resource provider.

FIG. 6 illustrates the map handler component 602 configured to provide a map 502 to a client such as the browser 312. FIG. 7 illustrates a map handler component 602 adapted to operate in the execution environment 702. The map can be provided as map information for presenting a representation of the map on a user interface. The map information can be stored in a map database 704 as illustrated in FIG. 7 and retrieved when requested and/or in response to detecting an access to a resource provider or a particular resource provided by a resource provider.

A map 502 can be provided based on a request and/or in response to a detected event by a map handler component 602. For example, when access to a resource associated with a particular task is detected by a resource provider 706₁ operating in the resource provider node 406, for example, a message notifying the map handler component 602 can be generated, as described above with respect to the notify message 453. The message 453 can be transmitted via the network 408 and received by the map handler component 602 operating in a map service 706₂ operating in the node 410. Alternatively, a notify message can be sent to a map handler component of a map service operating in an execution environment provided by a map service node 404. Alternatively, the message can be transmitted internally from a request handler component 708 of a map service/resource provider 7063 to a map handler component 602 operating in the same execution environment 702 as the request handler component 708 provided by the node 410. In one aspect map information for a map 502 can be retrieved and/or generated based on data stored in a map database 704.

A map can be provided by the map handler component 602 (and/or the map handler component 202) in any number of formats including various image formats (TIFF, JPEG, etc), SVG, a data stream, and/or as executable code for drawing a map. A provided map 502 can be any type of map. Exemplary types of maps include geopolitical maps illustrated as a map 502A in FIG. 5A, a topographical map as illustrated by a map 502B in FIG. 5B, a meteorological map, a street or highway map as illustrated in a map 502C in FIG. 5C, and maps of virtual spaces such as map for navigation one or more web sites. Additional types of maps can include a population map, a historical map, a geological map, a business map, a tour map, a treasure map, an economic map, an astronomy map, an astrology map, and the like.

Each provided map 502 represents a geospatial region, real world and/or virtual. A resource provided by a resource provider hosted by a node having a network interface accessible via a network address for communication over the network 408 has a location in the represented region. The resource can be located at the location, can represent the location, and/or can be associated with the location in any other way. For example, the resource can be a web application providing a web site for a company having a location in the region. The web application can be operating on a node at the location or in any other location. Through the relationship of the web application and the company, the web application can be said to have the location in this example. In an aspect, the geospatial region is associated with a domain in a geospatial domain space having a geospatial identifier identifying the geospatial region. The geospatial identifier can be at least a portion of a geospatial network address and/or a geospatial network name. In yet another aspect, a network identifier of the resource is a geospatial network identifier including at least one of the network address and a network name or other symbolic network identifier representing the network address.

Returning to FIG. 1, in block 104 resource information identifying the resource to the resource provider node and location information identifying a map location representing the geospatial location in the map representing the geospatial region are received. Accordingly, a system for accessing a resource based on metadata associated with a location on a map includes means for receiving resource information identifying the resource to the resource provider node and location information identifying a map location representing the geospatial location in the map representing the geospatial region. For example, as illustrated in FIG. 2, a content handler component 206 (e.g., text/html content handler component 206A, application/cmpp−xml content handler component 206B, image/svg+xml content handler component 206C, image/jpeg content handler component 206D, etc.) is configured to receive resource information identifying the resource to the resource provider node and location information identifying a map location representing the geospatial location in the map representing the geospatial region.

FIG. 3 illustrates a content handler component 206 adapted to operate in the execution environment 302. From a client perspective (see FIG. 2 and FIG. 3), a content handler component 206 can be configured to receive resource information and/or location information of a resource. For example, a content handler component 206A can be configured to process HTML (hypertext markup language) resource information. HTML resource information and/or location information can be received from a resource provider hosted by the resource provider node 406 via the network 408. The resource information and/or location information included in and/or along with the HTML information can be received by a network stack 320 as illustrated in FIG. 3 including a network interface card (NIC) (not shown). The HTML information can be received in an HTTP response such as the response message 451B to an HTTP command issued as in get message 451A in response to a user input received via an input subsytem 322. The content handler component 206 can also receive the resource information and/or location information in a result sent in response to other query requests. The HTTP response can be provided by the network stack 320 to an HTTP layer 324 for delivery to the application (e.g., the browser 312) that sent the corresponding HTTP command (get message 451A). Similarly, resource information and/or location information can be provided to other higher layer protocols by the network stack 320. An XMPP layer 326 is also illustrated as an exemplary protocol that can be configured to receive resource information by a content manager component 208 of the browser 312.

Content of the HTTP response can be provided to the content manager component 208. The content manager component 208 can be configured to route received data based on the received data's type, typically indicated by a MIME type included in the received message. For example, the HTML information included in received resource information can be provided by the content manger component 208 to a content handler component 206A configured to process content with a MIME type of text/html.

The resource information and location information can include content such as the HTML information, data in the message that delivered the content such as content headers in an HTTP response message, and/or any information accessible via the execution environment 302, the browser 312, and/or any other components and applications operating in the execution environment 302. The resource information includes an identifier of the resource that identifies the resource to the resource provider node 406 or the node 410 operating as a resource provider. For example, the resource information can include an identifier of static resource such as a file and/or, an application operating in an execution environment hosted by the resource provider node 406. A path portion and/or a query portion of a URL can identify a resource to the resource provider, for example. Additionally or alternatively, the resource information can be at least partially included and/or includable in a payload portion of a message. For example, a form field identifier and/or form field value can identify a resource to a resource provider.

Other content handler components 206 can be included in the browser 312 for receiving portions of resource information identifying the source of the resource and location information identifying the map location, typically via at least a portion of a source URL included in a portion of the resource information. FIG. 3 illustrates additional exemplary content handler components including a content handler component 206B for processing instant messages and publish-subscribe protocol messages including commands such as presence commands formatted according to the XMPP-IM specification, a content handler component 206C for processing SVG based content, and a content handler component 206D for processing JPEG resource information.

Turning now to FIG. 6, from a map service/resource provider perspective, a content handler component 606 can be configured to receive resource information identifying the resource and location information identifying the map location. The resource information and location information can be included in a message from a client node 402 for retrieving map information for presenting a web page, image data, audio data, and/or other presentable resource information. For example, the resource information can be (and/or can include) a path portion of a URL for retreiving a presentable resource identified by the path portion to a resource provider. For example, the URL path can be “index.html” or blank to indicate a configured default path portion to a resource provider operating in a resource provider node with a network interface identified by the network name “www.uspto.gov” for retrieving the home page of the US Patent and Trademark Office to be displayed in a content widget 506, such as the content widget 506A in FIG. 5A.

Alternatively, a request can be received from the client node 402 for retrieving a map 502A associated with a resource identified in resource information included in the request and/or associated with received location information. For example, map information for a map of the US can be retrieved for resources having locations in the United States, such as web pages provided by the USPTO resource provider node 406. The content handler component 606 can be included in a resource provider 706₁ and/or a map service 706₂. Note that the resource provider can run separate from the map service or can be integrated as illustrated in FIG. 7.

In addition to a resource identifier, such as a path portion of a URL, a request can include an identifier of a task, a user, browser information, and/or any information accessible to the client node 402. The message can identify any attribute accessible to the resource in addition to identifying the resource.

Alternatively, the resource information and/or location information can be included in a message from the resource provider node 406 to the map service node 404. The content handler component 606 of the sending resource provider node 406 and the map handler component 602 of the receiving map service node 404 can both receive resource information identifying the resource and/or the location information. In a further alternative, the resource provider 706₁ and map service 706₂ can operate in the same execution environment 702 as illustrated in FIG. 7. The resource information and/or location information can be provided to the content handler component 606 as information included in a request for accessing the resource and/or a map information for a map. Alternatively, the resource information and/or location information can be received for generating a message for providing a presentable representation of an identified resource to send to a node, such as the client node 402 to be presented by an application, such as the browser 312.

It should be noted that any of the map service node 404, the resource provider node 406, and the map service/resource provider node 410 and other nodes (not shown) can be configured to send resource information for a resource and/or location information for the geospatial location to the content handler component 206 operating in the client node 402. Any of the nodes can provide resource information and/or location information based on receiving information identifying the resource, the resource provider, and/or the resource provider node. Resource information can be identified or otherwise generated by a node based on the identified resource. Location information can be included and/or received along with in the resource information identifying a geospatial location of the resource in a region and/or a corresponding location on a map. In an aspect, location information can be determined by sending a query including a network address and/or network name of the network interface of the resource provider node to a domain name server to return location information stored in a LOC record. Analogously, a network address for accessing the resource can be determined based on the location information as described in U.S. application Ser. Nos. 12/170,281, 12/170,829, and 12/170,833. The resource information can be associated as resource metadata with the location on the map. The network address can be determined based on the map location. The map location identifies the geospatial location associated with the network address of the network interface of the resource provider node. The resource information can be sent to the content handler 206 for processing in correspondence with the resource.

The geospatial location of the resource in the geospatial region can be determined based on the resource information. Accordingly, a system for accessing a resource based on metadata associated with a location on a map may include means for determining the geospatial location of the resource in the geospatial region based on the resource information. For example, as illustrated in FIG. 2, a geospatial identifier (GSI) resolver component 210 can be configured to determine the geospatial location of the resource in the geospatial region based on the resource information.

The location in the geospatial region can be included in the resource information and/or determined from the resource information. For example, location information can be included in an identifier of the resource, resource provider, and/or resource provider node. For example, the geospatial network identifier of the resource provider node identifies a location at least partially included in at least one of the geospatial location and the map location of the resource provider. The resource can be identified with a geospatial network identifier such as a geospatial network address and/or a geospatial network name where the location can be determined from location in formation in the geospatial network name and/or the geospatial network address. The location can be identified in location information included in a header, a trailer, and/or a payload (i.e. the content) of the resource information message. For example, the location of the resource and/or resource provider can be specified as metadata included in a portion of the message identified as metadata and/or included in the resource as metadata. HTML, for example, supports metadata tags included in an HTML resource. The location information can be a reference. The GSI resolver component 210 can be configured to determine the location by accessing the location information directly and/or via a reference. When included in a message location information can have a MIME type associated with it where the MIME type defines a data format for metadata including location information.

Alternatively, the GSI resolver component 210 can be configured to receive a network identifier from the content manager component 208, map handler component 202, or other component configured to provide the network identifier based on the received message including resource information. The GSI resolver component 210 can be configured to query a directory service such as a DNS (domain name system) to retreive the location information of the resource such as a network address included in a message header of a message providing access to the resource information or a node name included in a host portion of a URL (uniform resource locator). In a DNS system, the GSI resolver component 210 can be configured to query a DNS service where the query includes an IP address of the resource provider for retrieving location information in a LOC (location) record. When a DNS host name is provided to a GSI resolver component 210, the host name can be resolved to an IP address. The IP address then can be resolved to associated location information for the resource provider node 406, 410. Other NDSes can allow location lookup directly based on a name of the resource provider node as described in U.S. application Ser. Nos. 12/170,281, 12/170,829, and 12/170,833.

FIG. 6 illustrates, from a map service/resource provider perspective, a geospatial identifier (GSI) resolver component 610 can be configured to determine the location of a resource, resource provider, and/or resource provider node in the geospatial region. For example, resource information including the location of an identified resource can be sent to a client node 402 either in response to a request received by a request handler component 708 or generated for sending as an asynchronous message by the request handler component 708. The GSI resolver component 610 can be configured to retrieve the location of the identified resource. The resource can be the resource provider 706₁, the resource provider node, or a resource provided by the resource provider 706₁. The location of the resource can be retrieved from a configuration store accessible locally or remote from the resource provider node 406, 410.

GSI resolver component 610 can be invoked to determine a location of a resource by a map handler component 602 and/or by a request handler component 708. A GSI resolver component 610 can be invoked to determine the location of a resource based on a resource identifier received in a request for the resource, a request for a map identifying the resource, resource provider, and/or resource provider node corresponding to a request for the resource, and/or in response to an asynchronous message for transmitting information identifying the resource to a client node 402. For example, the message can be sent as a notification message in a pub-sub protocol such as a presence protocol in response to an updated representation(s) in a model database 710 including data tuples. The model database 710 can be accessed and otherwise managed by a model manager component 712.

The resource information can be sent in any number of formats including image data, audio data, and/or text data including HTML pages and XML formatted pub-sub data. For example, when a request for a web page is received, the request can be routed to an appropriate request handler component 708 by a content handler component 606. The request handler component 708 can retrieve a pre-generated HTML page as resource information 714 and/or an HTML template as a resource template 716 for generating the resource information. The resource information and/or resource information template can be retrieved from a page/template database 718.

For dynamically generated portions of an HTML page, the request handler component 708 can be configured to invoke the model manager component 712, which can provide parameter information based on the request and or the HTML template. The model manager component 712 can retrieve data from the model database 710 in response to the request and provide it to the request handler component 708. The request handler component 708 can also generate the HTML-based resource information based on the model data provided by the model manager component 712.

The request handler component 708 can be configured to invoke the GSI resolver component 610 to determine the location of the resource. The GSI resolver component 610 can be configured to determine the location information of the resource in any manner analogous to that described for the GSI resolver component 210. When a resource maintains a fixed location, the location representation can be retrieved by the GSI resolver component 610 from a configuration store. If the resource is mobile, the GSI resolver component 610 can be configured to determine the resource information via any method analogous to those performed by the GSI resolver component 210 in the client node 402.

Alternatively, the resource information can be received from a map service 706₂ by a client or by a remote resource provider. The request can be routed from the content handler component 606 to the map handler component 602. The map handler component 602 can be configured to provide the resource information or just the identifier of the resource to the GSI resolver component 610 to determine a location as described above.

Alternatively or additionally, a URI (uniform resource identifier) for accessing the resource can include a scheme modifier defined for accessing location information of the resource and/or resource provider. U.S. patent application Ser. No. 11/615,438, titled “Methods and Systems for Determining Scheme Handling Procedures for Processing URIs Based on URI Scheme Modifiers,” filed on Dec. 22, 2006, and hereby incorporated by reference in its entirety, describes scheme modifiers and exemplary uses. Further, location information can be located based on a network identifier of a resource provider node as described in U.S. application Ser. Nos. 12/170,281, 12/170,829, and 12/170,833. The descriptions include determining a location via a query to a border node using an outside-scope network identifier and a query to a multicast server.

Resource metadata is generated based on the resource information. Accordingly, a system for accessing a resource based on metadata associated with a location on a map may include means for generating resource metadata based on the resource information. For example, as illustrated in FIG. 2, the map handler component 202 can be configured to generate resource metadata based on the resource information.

Resource metadata can include location information identifying a location associated with the resource, a resource identifier such as at least a portion of a URL of the resource such as a path and/or query portion of the URL. An icon, short description, and/or presentable representation of the resource can be included in the metadata as well. The presentable representation can be a reduced size presentable representation and can be presentable in a menu item, a list, and a map. The metadata can be stored in a record in the map database 304 by the map handler component 202. The metadata can be indexed using one or more elements of the record such as a location identifier in the location representation.

Turning now to FIG. 6, from a map service/resource provider perspective, the map handler component 602 can be configured to generate resource metadata in a manner analogous that described above with respect to the client map handler component 202. A map service and/or a resource provider can store the metadata in the map database 704 and/or can provide the metadata to the client map handler component 202 for storage by the client as described above.

An additional example of data that can be included in the resource metadata usable for accessing a resource and/or for determining when an association between resource metadata and a location on a map is to be presented and/or activated on a map includes metadata received from a user. The metadata from the user can include metadata in creating an association, in modifying an association, and/or at the time resource metadata is accessed via an associated location for accessing a resource. A further example includes context information such as an active mode of the browser 312 and/or a task associated with the resource. Still, further, resource metadata can include and be associated with a resource accessed prior to and/or after the resource associated with the resource metadata, which allows resource metadata to be linked or chained for presenting, for example, steps in a workflow and/or a browsing history.

Returning to FIG. 1, in block 106 the resource information is associated as resource metadata with the map location. Accordingly, a system for associating the resource information as resource metadata with a map location in the map includes means for associating the resource information as resource metadata with the map location. For example, as illustrated in FIG. 2, a navigation space handler (NSH component) component 204 is configured to associate the resource information as resource metadata with the map location.

FIG. 3 illustrates a NSH component 204 adapted to operate in the execution environment 302. The NSH component 204 can be configured to determine a map location that corresponds to the location of the resource in the geospatial region. Further, the NSH component 204 can be configured to determine a presentation space address corresponding to the location in the map and location of the resource the geospatial region. The map location and/or presentation space location can be determined dynamically. When the map location and/or the presentation space location is determined dynamically, the association between the map location and the metadata can be indirect and maintained in location information in the resource metadata record. Otherwise a determined map location and/or presentation space location can be stored in the map database 304 by the map handler component 202. This mapping operation is described in detail in U.S. application Ser. No. ______ (Attorney Docket No. I508).

FIG. 7 illustrates a network space handler (NSH) component 604 adapted to operate in the execution environment 702. The NSH component 604 is configured to associate resource metadata with a location in the map representing the determined location in the represented region of the resource. This process can be performed in a manner analogous to those applicable to the NSH component 204. A NSH component 604 can be configured to associate the metadata with the map location based on the gesopatial location of the resource allowing the client NSH component 204 to associate the resource metadata with a presentation space address corresponding to the map location in a presented representation of a map.

A visual representation of the association can be presented in a presentation of a map, for example, by providing a visual representation of the resource and/or resource information, such as a resource indicator, in the map at the map location associated with the metadata in correspondence with presenting the representation of the resource in a page or tab widget.

Returning to FIG. 1, in block 108 access to the resource via the map with the network address identifying the network interface of the resource provider node determined based on the geospatial location represented by the map location and the resource metadata identifying the resource to the resource provider node is provided for. Accordingly, a system for accessing a resource based on metadata associated with a location on a map includes means for providing for accessing the resource via the map with the network address identifying the network interface of the resource provider node determined based on the geospatial location represented by the map location and the resource metadata identifying the resource to the resource provider. For example, as illustrated in FIG. 2, a content manager component 208 is configured to access the resource via the map with the network address identifying the network interface of the resource provider node determined based on the geospatial location represented by the map location and the resource metadata identifying the resource to the resource provider.

FIG. 3 illustrates a content handler component 208 adapted to operate in the execution environment 302. In an example, a selection of the representation of the resource/resource information can be received via the input subsystem 322. The input subsystem can provide input information to the GUI manager component 318. The GUI manager component 318 can determine a widget handler component associated with the input, such as the map widget handler component 306 in response to a mouse click, for example, with the mouse pointer over the map location associated with the resource metadata. As a result, the GUI manager component 308 can send input information to the map widget handler component 306 for processing. The map widget handler component 306 can invoke the NSH component 204 to translate a presentation space address received in the input representation to a map location address and/or a region location and/or other identifier of the resource in the region. Using either the map location or the region location as an index depending on the configuration and content of resource information records in the map database, the NSH component 204 or the map widget handler component 306 can invoke the map handler component 202 to locate a resource metadata record associated with the received input based on the presentation address associated with the input.

The network address can be determined based on the location, in the geospatial region, of the resource, resource provider, and/or resource provider node. See U.S. application Ser. Nos. 12/170,281, 12/170,829, and 12/170,833, and U.S. application Ser. No. ______ (Attorney Docket No. I496) for descriptions of methods and systems for determining a network address based on location information. Once determined, the network address of the resource can be stored in the resource metadata record. The network address along with additional metadata such as a URL scheme identifier, path portion of a URL, and query portion of a URL can be assembled by the map handler component 202 (or stored preassembled in the resource metadata). The URL can be for accessing the resource.

The network address can be provided to the content manager component 208 to generate a message including the resource identifier, such as a URL based on the network address. The message including the resource identifier can be provided to a protocol layer compatible with communication with the network service provider identified. For example, a message including a URL with an XMPP scheme can be provided to an XMPP layer 326 for sending the message via the XMPP protocol to a resource provider node 406 for accessing the identified resource. Analogously, a resource identified by an HTTP URL can be provided in a message to the HTTP layer 324 for sending to a resource provider node 406 for accessing the resource. The messages can be sent to the resource provider node 406 via the network stack 320 for transmitting over the network 408 to the resource provider node 406.

FIG. 7 illustrates a content handler component 608 adapted to operate in the execution environment 702, from a map service/resource provider perspective. The content manager component 608 is configured to access an identified resource based on the metadata and network address. The content manager component 608 of a map service 706₂ can receive a request for a resource where the request identifies a map and a location in the map of the resource. The content manager component 208 of the browser 312 can generate the request based on the map and map location as identified by the NSH component 204 based on the presentation address received in the input representation. The content handler component 608 can provide the request to the map handler component 602. The map handler component 602 can locate a resource metadata record stored in the map database 704 as described above. Alternatively, resource metadata records can be indexed based on identifiers of locations of resources in geospatial regions. In this alternative, the map handler component 602 can invoke a NSH component 604 to determine a geospatial location in a geospatial region corresponding to the received map location in a map representing the geospatial region. Based on the geospatial location, the map handler component 602 can retrieve the resource metadata record identified by the geospatial location. Based on the resource metadata, an identifier of the resource can be determined as described above. If the resource is provided by a resource provider 706₁ operating in the same execution environment 702 as the map service 7062, then a network address need not be determined. The local resource identifer can be provided to the content manager component 608 for processing as a resource request from the client node 402 to request the resource from the resource provider 706₁. The request can be routed to an appropriate request handler component 708, for example, based on at least a portion of the URL path for retrieving the resource identified. The content manager component 608 can be configured to send a response message including resource information of the identified resource such as an image and/or a web page.

If the identified resource is not managed by a resource provider 706₁ operating in the same execution environment as the map service provider 706₂, the map handler component 602 can be configured to invoke the GSI resolver component 610 to determine a network address of a resource provider node using one of the methods described above and in U.S. application Ser. Nos. 12/170,281, 12/170,829, and/or 12/170,833. The map handler component 602 can provide the determined URL based on the network address and the resource metadata representation to the content manager component 608. The content manager component 608 can send the URL to the client node 402 to redirect the client request to the resource provider node 406 identified by the network address and the URL. Alternatively, the content manager component 608 can provide access to the resource by requesting the resource from the resource provider 706₁. Still further, the content manager component 608 can send a message to the identified resource provider node 406 where the resource provider 706₁ can be configure to generate a message including the resource to send to the client node 402. For example, the content manager component 608 can send a command to the resource provider node 406 causing the content manager component 608 of the resource provider 706₁ to generate a notification message to send resource information of the identified resource to the browser 312 in the client node 402.

It should be understood that the various system components (and means) defined by the claims and illustrated in the various block diagrams represent logical components that are configured to perform the functionality described herein. While at least one of these components are implemented at least partially as an electronic hardware component, and therefore constitutes a machine, the other components may be implemented in software, hardware, or a combination of the two. More particularly, at least one component defined by the claims is implemented at least partially as an electronic hardware component, such as an instruction execution machine (e.g., a processor-based or processor-containing machine) and/or as specialized circuits or circuitry (e.g., discrete logic gates interconnected to perform a specialized function). Other components may be implemented in software, hardware, or a combination of the two. Moreover, some or all of these other components may be combined, some may be omitted altogether, and additional components can be added while still achieving the functionality described herein. Thus, the subject matter described herein can be embodied in many different variations, and all such variations are contemplated to be within the scope of what is claimed.

To facilitate an understanding of the subject matter described above, many aspects are described in terms of sequences of actions. At least one of these aspects defined by the claims is performed by an electronic hardware component. For example, it will be recognized that the various actions can be performed by specialized circuits or circuitry, by program instructions being executed by one or more processors, or by a combination of both. The description herein of any sequence of actions is not intended to imply that the specific order described for performing that sequence must be followed. All methods described herein can be performed in any suitable order unless otherwise indicated herein or otherwise clearly contradicted by context.

Moreover, the methods described herein can be embodied in executable instructions stored in a computer readable medium for use by or in connection with an instruction execution machine, apparatus, or device, such as a computer-based or processor-containing machine, apparatus, or device. As used here, a “computer-readable medium” can include one or more of any suitable media for storing the executable instructions of a computer program in one or more of an electronic, magnetic, optical, and electromagnetic, such that the instruction execution machine, system, apparatus, or device can read (or fetch) the instructions from the computer readable medium and execute the instructions for carrying out the described methods. A non-exhaustive list of conventional exemplary computer readable medium includes: a portable computer diskette; a random access memory (RAM); a read only memory (ROM); an erasable programmable read only memory (EPROM or Flash memory); optical storage devices, including a portable compact disc (CD), a portable digital video disc (DVD), a high definition DVD (HD-DVD™), a Blu-ray™ disc; and the like.

The use of the terms “a” and “an” and “the” and similar referents in the context of describing the subject matter (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illuminate the subject matter and does not pose a limitation on the scope of the subject matter unless otherwise claimed. No language in the specification should be construed as indicating any non-claimed element as essential to the practice of the invention as claimed.

Preferred embodiments are described herein, including the best mode known to the inventor for carrying out the claimed subject matter. Of course, variations of those preferred embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

What is claimed is:

1. A method for accessing a resource based on metadata associated with a location on a map, the method comprising:
providing a map representing a geospatial region, wherein a resource accessible via a network address identifying a network interface of a resource provider node has a geospatial location in the geospatial region, the geospatial location associated with the network address;
receiving resource information identifying the resource to the resource provider node and location information identifying a map location representing the geospatial location in the map representing the geospatial region;
associating the resource information as resource metadata with the map location; and
providing for accessing the resource via the map with the network address identifying the network interface of the resource provider node determined based on the geospatial location represented by the map location and the resource metadata identifying the resource to the resource provider node,
wherein at least one of the preceding actions is performed on at least one electronic hardware component.

2. The method of claim 1 wherein the resource is a resource provider.

3. The method of claim 1 wherein providing the map comprises providing at least one of a geopolitical map, a topographical map, a road map, a population map, a historical map, a geological map, a business map, a tour map, a treasure map, an economic map, an astronomy map, an astrology map, and a meteorological map.

4. The method of claim 1 wherein providing the map is performed by a browsing application.

5. The method of claim 1 wherein the geospatial region is associated with a domain in a geospatial domain space having a geospatial identifier identifying the geospatial region.

6. The method of claim 5 wherein the geospatial identifier is at least a portion of one of a geospatial network address and a geospatial network name.

7. The method of claim 1 wherein a network identifier of the resource is a geospatial network identifier in the form of one of the network address and a network name representing the network address.

8. The method of claim 7 wherein the geospatial network identifier of the resource identifies a location at least partially included in at least one of the geospatial location and the map location of the resource.

9. The method of claim 1 wherein receiving the resource information comprises receiving the resource information in a result sent in response to a prior query request.

10. The method of claim 1 wherein the geospatial location of the resource is in at least one of a network name and a network address provided in the resource information.

11. The method of claim 1 wherein the resource information is received in a message and the location information is included in at least one of a header, a trailer, and a payload of the message.

12. The method of claim 1 wherein the location information is received in response to querying a directory service to retrieve location information of the resource.

13. The method of claim 1 wherein associating the resource information comprises associating the information as metadata with a presentable representation.

14. The method of claim 13 wherein the presentable representation is presentable in at least one of a menu item, a list, and a map.

15. The method of claim 13 wherein providing for accessing the resource includes translating an identifier of a location in a presentation space address of the presentable representation to an identifier of the map location.

16. The method of claim 1 wherein providing for accessing the resource comprises requesting the resource.

17. The method of claim 1 further comprising presenting a representation of the resource in a user interface widget in response to receiving the resource information.

18. The method of claim 17 further comprising in response to associating the metadata with the map location, presenting a resource indicator associated with the resource at the map location on the map in correspondence with presenting the representation of the resource in the user interface widget.

19. A system for accessing a resource based on metadata associated with a location on a map, the system comprising components including:
means for providing a map representing a geospatial region, wherein a resource accessible via a network address identifying a network interface of a resource provider node has a geospatial location in the geospatial region, the geospatial location associated with the network address;
means for receiving resource information identifying the resource to the resource provider node and location information identifying a map location representing the geospatial location in the map representing the geospatial region;
means for associating the resource information as resource metadata with the map location; and
means for providing for accessing the resource via the map with the network address identifying the network interface of the resource provider determined based on the geospatial location represented by the map location and the resource metadata identifying the resource to the resource provider,
wherein at least one of the means includes at least one electronic hardware component.

20. A system for accessing a resource based on metadata associated with a location on a map, the system comprising system components including:
a map handler component configured to provide a map representing a geospatial region, wherein a resource accessible via a network address identifying a network interface of a resource provider node has a geospatial location in the geospatial region, the geospatial location associated with the network address;
a content handler component configured to receive resource information identifying the resource to the resource provider node and location information identifying a map location representing the geospatial location in the map representing the geospatial region;
a navigation space handler component configured to associate the resource information as resource metadata with the map location, the content handler component further configured to provide for accessing the resource via the map with the network address identifying the network interface of the resource provider determined based on the geospatial location represented by the map location and the resource metadata identifying the resource to the resource provider,
wherein at least one of the system components includes at least one electronic hardware component.

21. The system of claim 20 wherein the resource is a resource provider.

22. The system of claim 20 wherein the map handler component provides at least one of a geopolitical map, a topographical map, a road map, a population map, a historical map, a geological map, a business map, a tour map, a treasure map, an economic map, an astronomy map, an astrology map, and a meteorological map.

23. The system of claim 20 wherein the map handler component is configured to provide the map via a browsing application.

24. The system of claim 20 wherein the geospatial region is associated with a domain in a geospatial domain space having a geospatial identifier identifying the geospatial region.

25. The system of claim 24 wherein the geospatial identifier is at least a portion of at least one of a geospatial network identifier and a geospatial network name.

26. The system of claim 20 wherein a network identifier of the resource is a geospatial network identifier in the form of at least one of the network address and a network name representing the network address.

27. The system of claim 26 wherein the geospatial network identifier of the resource identifies a location at least partially included in at least one of the geospatial location and the map location of the resource.

28. The system of claim 20 wherein the content handler component receives the resource information in a result sent in response to a prior query request.

29. The system of claim 20 wherein a geospatial identifier resolver component is configured to determine the location information in at least one of a network name and a network address provided in the resource information.

30. The system of claim 20 wherein the resource information is received in a message and a geospatial identifier resolver component locates the location information in one of a header, a trailer, and a payload of the message.

31. The system of claim 20 wherein a geospatial identifier resolver queries a directory service to retrieve location information of the resource.

32. The system of claim 20 wherein the navigation space handler component associates the resource information as resource metadata with a presentable representation.

33. The system of claim 20 wherein the navigation space handler component translates a presentation space address of the presentable representation to a map location.

34. The system of claim 20 wherein the content handler component provides for accessing the resource by requesting the resource from the resource provider.

35. A computer readable medium storing a computer program, executable by a machine, for accessing a resource based on metadata associated with a location on a map, the computer program comprising executable instructions for:
providing a map representing a geospatial region, wherein a resource accessible via a network address of a resource provider node has a geospatial location in the geospatial region, the geospatial location associated with the network address;
receiving resource information identifying the resource to the resource provider node and location information identifying a map location representing the geospatial location in the map representing the geospatial region;
associating the resource information as resource metadata with the map location; and
providing for accessing the resource via the map with the network address of the resource provider determined based on the geospatial location represented by the map location and the resource metadata identifying the resource to the resource provider.
